(19) United States
(12) Patent Application Publication
(10) Pub. No.: US 2026/0313350 A1
(43) Pub. Date: Oct. 8, 2026

(54) DYNAMIC SIM VALUE UPDATE

(71) Applicant: T-MOBILE INNOVATIONS LLC, Overland Park, KS (US)

(72) Inventor: Cody Lee TAYLOR, North Bend, WA (US)

(21) Appl. No.: 19/169,596

(22) Filed: Apr. 3, 2025

(51) Int. Cl. H04W 8/18

(52) U.S. Cl. CPC H04W 8/18

(57) ABSTRACT

Embodiments of the present disclosure is directed to systems, computer readable media, and methods for causing dynamic updates to values of a Subscriber Identity Module (SIM). In embodiments, the operations comprise accessing, at a telecommunication network, an indication that a SIM of a user device is a unified SIM, based on accessing the indication, transmitting a first instruction to the user device, the first instruction causing display of a brand selection interface on a graphical user interface (GUI) of the user device, the brand selection interface comprising a plurality of brands, receiving, from the user device, a selected brand of the plurality of brands; and responsive to receiving, causing at least one file of the unified SIM to be updated to an amended file.

### SUMMARY

The present disclosure is directed, in part, to dynamically updating the data or files of a SIM such that a carrier may utilize a unified SIM for multiple brands, substantially as shown in and/or described in connection with at least one of the figures, and as set forth more completely in the claims.

In aspects set forth herein, and at a high level, the technology described herein relates to utilizing an indication that a SIM of a user device is a unified SIM and based on this indication causing display of a brand selection interface comprising a plurality of brands associated with a carrier. Based on receiving a selection of a brand of the plurality of brands, at least one value of the unified SIM may be updated. This allows for SIMs to be dynamically updated based on updates provided by the telecommunication network rather than requiring that certain values be present in the initial SIM configuration. As such, unified SIMs may be updated after generation such that relevant values may be changed dynamically.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts a diagram of a network environment, in accordance with aspects herein;

FIG. 2 is a flow chart of a method for the dynamic updating of SIM values, in accordance with aspects herein; and

FIG. 3 depicts an example of a computing device, in accordance with one or more aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “network access technology (NAT)” is synonymous with wireless communication protocol and is an umbrella term used to refer to the particular technological standard/protocol that governs the communication between a UE (User Equipment) and a base station; examples of network access technologies include 3G, 4G, 5G, 6G, 802.11x, and the like. The term “node” is used to refer to an access point that transmits signals to a UE and receives signals from the UE in order to allow the UE to connect to a broader data or cellular network (including by way of one or more intermediary networks, gateways, or the like)

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, Mobile network operators (MNOs) may operate multiple brands, each with distinct service plans, policies, or network privileges. To differentiate between these brands, MNOs often use identifiers stored on a SIM card or embedded SIM, which help network systems determine the appropriate brand-specific services for a subscriber. These identifiers that may be stored on SIMs may include the Public Land Mobile Network (PLMN) code, which indicates the carrier’s network and helps user equipment (UE) determine which radio access networks (RANs) it can connect to; the Provider Name Number (PNN), which contributes to user experience by defining network display names and other branding elements shown in the UE’s graphical interface; and the Group Identifier Level 1 (GID1), which allows carriers to apply brand-specific policies, assign service features, and manage billing for different subscriber groups. These various identifiers enable carriers to distinguish between brands at the network level and provision services accordingly. However, assigning and managing these identifiers efficiently can pose challenges, particularly as networks require greater flexibility in provisioning and service updates.

Conventionally, SIM cards and eSIMs are generated with a specific Stock Keeping Unit (SKU) or other identifier which include values indicating features of a specific brand. For example, a carrier may have a brand 1 and a brand 2. This would require the generation of SIMs with a brand 1 specific SKU and that brand 1 specific SKU would have brand 1 specific values, such as a brand 1 specific PLMN, brand 1 specific PNN, or brand 1 specific GID 1 value. The SIMs for brand 2 would be generated with a brand 2 specific SKU having brand 2 specific values such as a brand 2 specific PLMN, brand 2 specific PNN or brand 2 specific GID 1 value. As such, every brand provided by a carrier requires the generation of SIM cards and eSIMs with the brand specific SKUs and values. And attempting to update these values after a SIM or eSIM has been activated can cause delays in services and inefficient use of limited telecommunication resources.

Unlike conventional solutions, the present disclosure provides a solution utilizing unified SIMs for carriers which have more than one brand. A telecommunication network may recognize unified SIMs when a unified SIM is first loaded to a user device, and based on recognizing that a SIM is a unified SIM, configure the brand for that unified SIM at activation. This avoids the need to produce brand specific SIMs and SKUs and allows for flexibility in SIMs not previously available. The telecommunication network may utilize a SIM applet to generate a brand selection interface comprising a plurality of brands. A user may select whichever brand of the carrier they would like and this selection is received by the telecommunication network which then communicates instructions to update at least one value of the SIM based on the selection. This remedies the inefficiencies present in multi-brand carrier SIM cards and allows for updates to SIM cards over systems such as Over-The-Air (OTA) to update SIM card information with an increase in efficiency, reduction in latency, and reduction in bandwidth use.

Accordingly, aspects provided herein are directed to a system, non-transitory computer storage media, and method for performing the operations of dynamic SIM value updating. The method, and operations of the system and non-transitory computer storage media comprise accessing, at a telecommunication network, an indication that a SIM of a user device is a unified SIM. Based on accessing the indication, a first instruction is transmitted to the user device, the first instruction causing display of a brand selection interface on a graphical user interface (GUI) of the user device, the brand selection interface including a plurality of brands. Receiving, from the user device, a selected brand of the plurality of brands, and responsive to receiving, causing at least one file of the unified SIM to be updated to an amended file.

When a carrier has more than one brand, this fact can affect the number of SIM cards or eSIMs they need to generate. This is due to the fact that traditionally, a distinct SIM needs to be generated for each and every brand. And each of these SIMs would have distinct SKUs for each brand of the same character. This is because the SKUs of each SIM would contain values related to each of the brands. A SKU is a Stock Keeping Unit, or a unique identifier that may be used by carriers to manage and track inventory such as an inventory of SIM cards. Each SKU may represent a specific version of a product. With respect to SIM cards as discussed herein, a SKU is used to identify different value configurations of SIM cards and eSIMs for various brands of a carrier.

For example, SKU 1 for brand 1 would have a brand 1 value for values such as PNN, PLMN, or GID 1. This value 1 may indicate, for example, that this brand 1 of the carrier has access to wireless calling or a certain data limit per month. Whereas brand 2 of the same carrier would, for example, not have access to wireless calling and has a lower data limit per month. Because these values were included in the SKUs of the SIMs at generation, it can be very difficult and time consuming to update the values at a later date if that option is even available. This causes inefficiencies in the telecommunication system and restrictions to the flexibility of SIMs.

These inefficiencies and this lack of flexibility can be remedied through the use of unified SIMs that do not require the preloading of specific brand values. A telecommunication system may determine when a unified SIM is generated, activated, or loaded into a new or used user device. This determination may be based on accessing in indication that a SIM card is a unified SIM card. This indication may be transmitted or received for example when a user buys a new phone and an eSIM or SIM card is first loaded onto the new device. The new device will recognize the SIM card and connect to an available network. The available network could be a telecommunication network or wireless network or any other form of network that a user device could connect to. Because the SIM is a unified SIM, the network will recognize that the values for the brand of the unified SIM needs to be updated from whatever value is originally included to a brand specific value. This update may be accomplished through the use of a software application such as a SIM applet.

By way of background, a SIM Applet is a software application which may be embedded in a SIM card, or stored in association with an eSIM. The SIM applet may enhance the functionality and flexibility of a SIM used in association with a telecommunication service. A SIM applet may operate within a SIM’s secure environment and interacts with the user device’s operating system to perform various tasks. As discussed herein, the SIM Applet may be caused to generate the brand selection interface which a user may utilize to select a brand of the carrier. Once the brand is selected, the telecommunication network may receive the selected brand and communicate instructions to update at least one file of the unified SIM. Updating this file may realize the selection of the brand such that the SIM and user device are updated with the features and permissions of the selected brand.

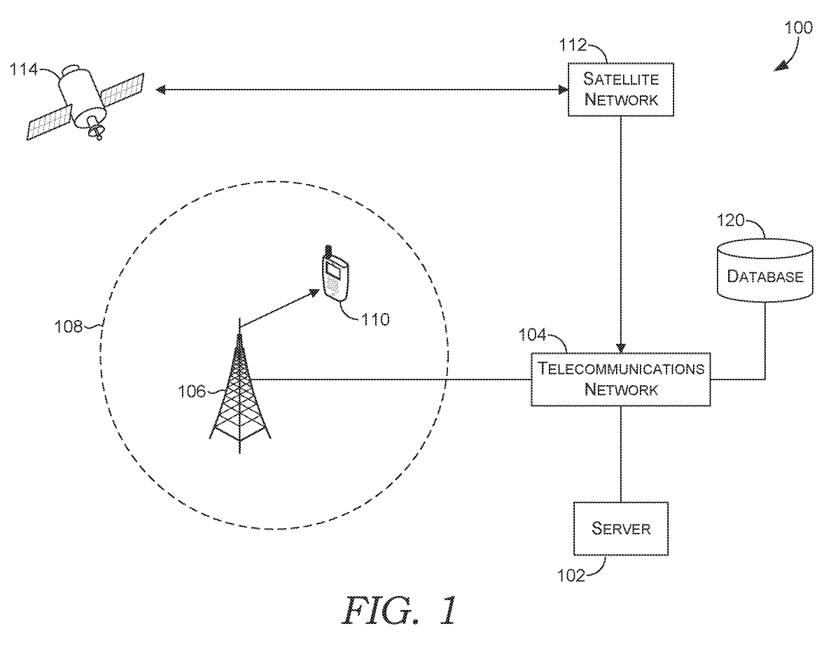

FIG. 1 depicts an example of a network environment 100, in accordance with aspects herein. The network environment 100 includes a server 102 having one or more processors. The server 102 operates within and thus is communicatively coupled to a telecommunications network 104 or its components. The telecommunication network 104 is communicatively coupled to the server 102, database 120, and one or more base stations 106. A base station may be associated with a corresponding coverage area 108. The one or more base stations 106 can provide telecommunications services to any number of user devices such as user device 110. User device 110 may be such a device represented by computing device 300. As discussed herein, the user device 110 may receive a new unified SIM at any stage. Once the unified SIM has been activated in the user device 110, the user device 110 may connect to the telecommunication network 104 or server 102, for example by connecting to a base station 106 for which the user device 110 is within its coverage area 108. When a SIM is inserted into a user device for the first time, the mobile device may read the information stored on the SIM card such as the International Mobile Subscriber Identity (IMSI) or authentication key identifier (Ki). The user device may then scan for an available network and select the appropriate one based on data such as PLMN identifiers. The IMSI is received by the network which responds with a challenge and the SIM generates a response using the Ki, for example, so that the network may verify the response to authenticate the SIM.

Based on connecting to the telecommunication network 104, the user device 110 may be caused to display a brand selection interface which may be utilized to select and update the user device 110 such that the associated SIM and SKU are updated based on a selection of a brand of the brand selection interface. This may comprise updating a value of the SIM such as the PNN, PLMN, or GID 1 files. Once this has been updated, the update may be communicated to the telecommunication network 104 for storage in a database 120 associated with the telecommunication network 104. The database 120, also described herein as a network data repository may be a hardware or software computing component communicatively coupled to the telecommunications network 104 and any number of user devices. The network data repository may store data associated with SIMs, user device, and identifiers indicating subscriber information which may be utilized or referenced by the user device 110, telecommunication network 104, or server 102. Once the brand has been selected, values of the SIM, user device, carrier, and brand, among other values, may be stored in the database 120 in association with a subscriber or user device identifier.

In the network environment 100 shown, the telecommunications network 104 interfaces with satellite network 112, which is also referred to as an aerospace network. In one aspect, the server 102 operates as, or is communicatively coupled to, a telecommunications core network component that acts as an interface between the satellite network 112 and the telecommunications network 104. The satellite network 112 can include one or more devices configured to act as aerospace access points, such as satellite 114. Although not shown, the satellite network 112 may interface with and communicate with one or more terrestrial radio elements that are not associated with the telecommunications network 104. The satellite 114 can provide connectivity to a user device such as a user device 110 which are located within the coverage area of the satellite 114.

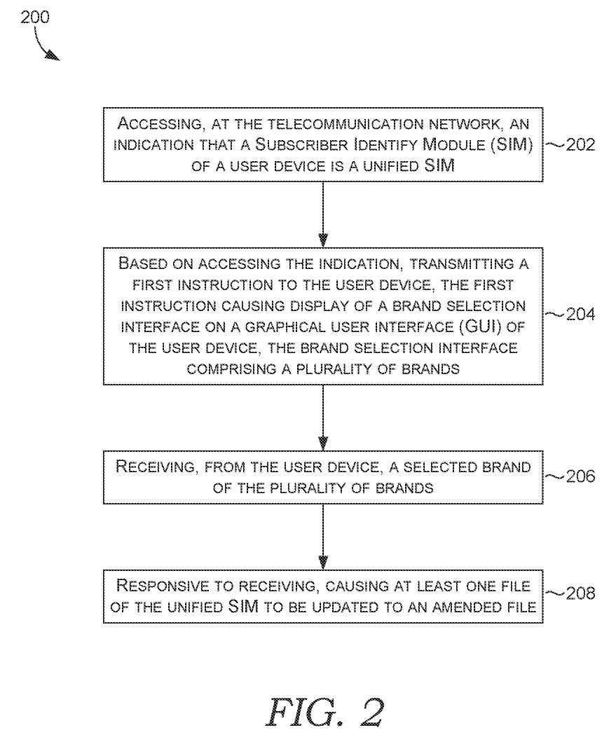

Turning now to FIG. 2 a flow chart is provided for a method 200 for dynamically updating one or more values of a SIM. At block 202, an indication that a SIM of a user device is a unified SIM is accessed by a telecommunication network such as telecommunication network 104. In embodiments, the indication is a placeholder value of a GID 1 file of the unified SIM. The indication that a SIM is a unified SIM may be any form of communication or data value that indicates to a telecommunication system that a SIM is a unified SIM. In additional or alternative embodiments, the indication may be any predetermined value of a file of the SIM.

When the SIM is first connected to the telecommunication service, or when the SIM is connected to a user device for a first time, the SIM may transmit a communication to the telecommunication system. This initial connection may be made through a connection between the user device 110 and base station 106. This communication may transmit any set of data such as the International Mobile Subscriber Identifier) IMSI or Integrated Circuit Card Identifier (ICCID). During any stage of the initial communication between a SIM and the telecommunication network, it may be determined that a SIM is a unified SIM. For example, when a SIM card connects to a telecommunication network for the first time, the process begins with the user inserting the SIM card into their mobile device, which then reads the stored information such as the IMSI and authentication key identifier (Ki). The device scans for available networks and selects the appropriate one based on the PLMN identifiers.

When the SIM finds the telecommunication network that it may connect to, the first communication it sends may be an indication that it is a unified SIM. This also may be included in the IMSI which is transmitted to the telecommunication network, which responds with a challenge. The SIM card generates a response using the Ki, and the network verifies this response to authenticate the subscriber. As such, the indication that a SIM is a unified SIM may additionally or alternatively be included in the Ki response. The device is then authenticated, and as discussed in more detail below, the telecommunication network may cause the brand selection interface to display on the user device so that a brand may be selected.

At block 204, a first instruction is transmitted to the user device based on the indication being accessed. The first instruction causes display of a brand selection interface on a graphical user interface of the user device and the brand selection interface comprises a plurality of brands. The brand selection interface may include information indicating the various brands that may be selected. The brand selection interface may be configured such that a selection of brand through interaction with the user device, such as a touch screen of the user device will trigger the selection of that brand.

At block 206, a selected brand of the plurality of brands is received from the user device. Once a user has made a selection through interaction with the user device, such as user device 110, the user device, or unified SIM associated with the user device may cause a transmission of the selected brand to the telecommunication system. At block 208, at least one file of the unified SIM is caused to be updated to an amended file responsive to receiving the selected brand. In embodiments, causing the at least one file of the unified SIM to be updated to an amended file comprises updating a Public Land Mobile Network Name file to an amended Public Land Mobile Name file. In additional or alternative embodiments, causing the at least one file of the unified SIM to be updated to an amended file comprises updating a GID 1 file to an amended GID 1 file. The at least one file may be caused to be updated to the amended file based on an Over the Air (OTA) update transmitted from the telecommunication network.

The user device configurations may be updated responsive to the brand selection. This update may include the brand specific information, according to the telecommunication network settings, and the connection is established, allowing the user to access, for example, voice, SMS, and data services depending on the brand selected. In embodiments, a second indication that the at least one file of the unified SIM has been updated to the amended file is received. Based on receiving this second indication, a subscriber identifier of the unified Sim is stored in a subscriber database of the telecommunication network in association with the amended file. In additional or alternative embodiments, instructions are transmitted to the user device to disable the brand selection interface. Disabling the brand selection interface may help avoid multiple selections or the transmission of additional data or requests that could negatively affect the bandwidth of a telecommunication network. This may also avoid errors that could occur with duplicate requests for the same brand or requests of that nature which will cause errors in the telecommunication network in association with the unified SIM.

In embodiments, the telecommunication network may additionally or alternatively receive a request to reenable the brand selection interface, and transmit instruction to the user device to reenable the brand selection interface. A user device may request that the brand selection interface be reenabled based on receiving an interaction at the user device wherein a user is requesting an update to the brand. In additional or alternative embodiments, the brand selection interface may be enabled at regular intervals, or at predetermined times to allow selection of an additional or alternative brand. For example, if a carrier updates their listing of brands or if features of a brand change, the telecommunication network may cause the brand selection interface to be reenabled so that a user may review and potentially select an alternative brand.

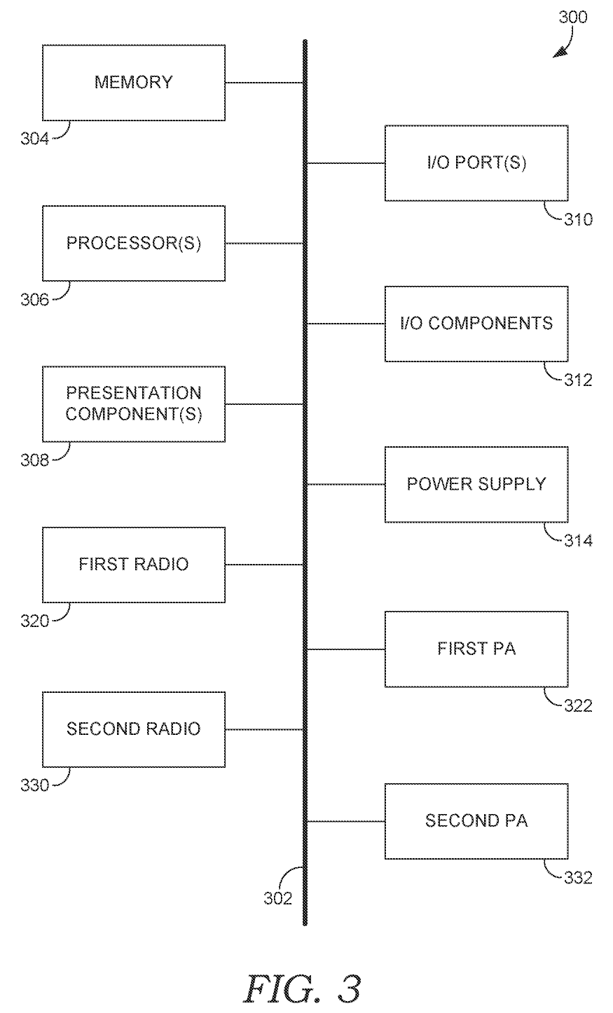

Having described an overview of some embodiments of the present technology, an example computing environment in which embodiments of the present technology may be implemented is described below in order to provide a general context for various aspects of the present technology. Referring to FIG. 3, an exemplary device is shown and designated generally as computing device 300 that is suitable for use in implementations of the present disclosure. Computing device 300 is but one example of a suitable computing environment and is not intended to suggest any limitation as to the scope of use or functionality of the invention. Neither should computing device 300 be interpreted as having any dependency or requirement relating to any one or combination of components illustrated. In aspects, the computing device 300 is generally defined by its capability to transmit one or more signals to a an access point and receive one or more signals from the access point (or some other access point); the computing device 300 may be referred to herein as a user equipment, wireless communication device, or user device, The computing device 300 may take many forms; non-limiting examples of the computing device 300 include a cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 3 computing device 300 includes bus 302 that directly or indirectly couples the following devices: memory 304, one or more processors 306, one or more presentation components 308, input/output (I/O) ports 310, I/O components 312, and power supply 314. Bus 302 represents what may be one or more busses (such as an address bus, data bus, or combination thereof). Although the devices of FIG. 3 are shown with lines for the sake of clarity, in reality, delineating various components is not so clear, and metaphorically, the lines would more accurately be grey and fuzzy. For example, one may consider a presentation component 308 such as a display device to be one of I/O components 312. Also, processors, such as one or more processors 306, have memory. The present disclosure hereof recognizes that such is the nature of the art, and reiterates that FIG. 3 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 3 and refer to “computer” or “computing device.”

Computing device 300 typically includes a variety of computer-readable media. Computer-readable media can be any available media that can be accessed by computing device 300 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. Memory 304 may be removable, nonremovable, or a combination thereof. Exemplary memory includes solid-state memory, hard drives, optical-disc drives, etc. Computing device 300 includes one or more processors 306 that read data from various entities such as bus 302, memory 304 or I/O components 312. One or more presentation components 308 presents data indications to a person or other device. Exemplary one or more presentation components 308 include a display device, speaker, printing component, vibrating component, etc. I/O ports 310 allow computing device 300 to be logically coupled to other devices including I/O components 312, some of which may be built in computing device 300. Illustrative I/O components 312 include a microphone, joystick, game pad, satellite dish, scanner, printer, wireless device, etc.

A first radio 316 and second radio 320 represent radios that facilitate communication with one or more wireless networks using one or more wireless links. In aspects, the first radio 316 utilizes a first transmitter 318 to communicate with a wireless network on a first wireless link and the second radio 320 utilizes the second transmitter 322 to communicate with a wireless network on a second wireless link. Though two radios are shown, it is expressly conceived that a computing device with a single radio (i.e., the first radio 316 or the second radio 320) could facilitate communication over one or more wireless links with one or more wireless networks via both the first transmitter 318 and the second transmitter 322. Illustrative wireless telecommunications technologies include CDMA, GPRS, TDMA, GSM, and the like. One or both of the first radio 316 and the second radio 320 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 316 and the second radio 320 may be configured to communicate using the same protocol but in other aspects they may be configure dot communicate using different protocols. In some embodiments, including those that both radios or both wireless links are configured for communicating using the same protocol, the first radio 316 and the second radio 320 may be configured to communicate on distinct frequencies or frequency bands (e.g., as part of a carrier aggregation scheme). As can be appreciated, in various embodiments, each of the first radio 316 and the second radio 320 can be configured to support multiple technologies and/or multiple frequencies.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system comprising:
a base station of a telecommunication network configured to wirelessly communicate with a user device;
a networked data repository; and
one or more networked computer processing components having computer-useable instructions stored thereon that, when used by one or more processors, cause the one or more processors to perform operations, the operations comprising:
accessing, at the telecommunication network, an indication that a Subscriber Identity Module (SIM) of a user device is a unified SIM;
based on accessing the indication, transmitting a first instruction to the user device, the first instruction causing display of a brand selection interface on a graphical user interface (GUI) of the user device, the brand selection interface comprising a plurality of brands;
receiving, from the user device, a selected brand of the plurality of brands; and
responsive to receiving, causing at least one file of the unified SIM to be updated to an amended file.

2. The system of claim 1, wherein causing the at least one file of the unified SIM to be updated to an amended file comprises updating a Public Land Mobile Network Name file to an amended Public Land Mobile Network Name file.

3. The system of claim 2, wherein causing the at least one file of the unified SIM to be updated to an amended file comprises updating a Group Identifier 1 (GID 1) file to an amended GID 1 file.

4. The system of claim 3, wherein the at least one file of the unified SIM is caused to be updated to the amended file based on an Over the Air (OTA) update transmitted from the telecommunication network.

5. The system of claim 3, wherein the indication is a placeholder value for a GID 1 file.

6. The system of claim 3, wherein the indication is an international mobile subscriber identity.

7. The system of claim 3, wherein the indication is an integrated circuit card identifier.

8. The system of claim 3, wherein the indication is a placeholder value of a Public Land Mobile Network Name file of the unified SIM.

9. The system of claim 3, wherein the operations further comprise:
receiving a second indication that the at least one file of the unified SIM has been updated to the amended file; and
based on receiving the second indication, storing a subscriber identifier of the unified SIM in a subscriber database of the telecommunication network in association with the amended file.

10. The system of claim 9, wherein the operations further comprise:
transmitting instructions to the user device to disable the brand selection interface.

11. A non-transitory computer storage media storing computer-useable instructions that, when used by one or more processors, cause the one or more processors to perform operations, the operations comprising:
accessing, at a telecommunication network, an indication that a Subscriber Identity Module (SIM) of a user device is a unified SIM;
based on accessing the indication, transmitting a first instruction to the user device, the first instruction causing display of a brand selection interface on a graphical user interface (GUI) of the user device, the brand selection interface comprising a plurality of brands;
receiving, from the user device, a selected brand of the plurality of brands; and
responsive to receiving, causing at least one file of the unified SIM to be updated to an amended file.

12. The non-transitory computer storage media of claim 11, wherein the operations further comprise:
receiving a second indication that the at least one file of the unified SIM has been updated to the amended file; and
based on receiving the second indication, storing a subscriber identifier of the unified SIM in a subscriber database of the telecommunication network in association with the amended file.

13. The non-transitory computer storage media of claim 12, wherein the operations further comprise:
transmitting instructions to the user device to disable to the brand selection interface.

14. The non-transitory computer storage media of claim 13, wherein the operations further comprise:
receiving a request to reenable the brand selection interface; and
transmitting instructions to the user device to reenable the brand selection interface.

15. A method for dynamically updating Subscriber Identity Module value, comprising:
accessing, at a telecommunication network, an indication that a Subscriber Identity Module (SIM) of a user device is a unified SIM;
based on accessing the indication, transmitting a first instruction to the user device, the first instruction causing display of a brand selection interface on a graphical user interface (GUI) of the user device, the brand selection interface comprising a plurality of brands;
receiving, from the user device, a selected brand of the plurality of brands; and
responsive to receiving, causing at least one file of the unified SIM to be updated to an amended file.

16. The method of claim 15, wherein the method further comprises:
receiving a second indication that the at least one file of the unified SIM has been updated to an amended file; and
transmitting instructions to the user device to disable to the brand selection interface.

17. The method of claim 16, wherein causing the at least one file of the unified SIM to be updated to an amended file comprises updating a Public Land Mobile Network Name file to an amended Public Land Mobile Network Name file.

18. The method of claim 17, wherein causing the at least one file of the unified SIM to be updated to an amended file comprises updating a Group Identifier 1 (GID 1) file to an amended GID 1 file.

19. The method of claim 16, wherein the at least one file of the unified SIM is caused to be updated to the amended file based on an Over the Air (OTA) update transmitted from the telecommunication network.

20. The method of claim 16, wherein the indication is a placeholder value of a Public Land Mobile Network Name file of the unified SIM.
